(19) United States
(12) Patent Application Publication
(10) Pub. No.: US 2025/0050970 A1
(43) Pub. Date: Feb. 13, 2025

(54) CONTROL MODULE FOR A BICYCLE

(71) Applicant: CLASSIFIED CYCLING BV, Antwerpen (BE)

(72) Inventors: Roëll Marie VAN DRUTEN, Eindhoven (NL); Thomas Jean VALERO, Antwerpen (BE)

(21) Appl. No.: 18/719,174

(22) PCT Filed: Dec. 23, 2022
(86) PCT No.: PCT/EP2022/087812

§ 371 Date: Jun. 12, 2024

(30) Foreign Application Priority Data
Dec. 24, 2021 (NL) 2030296
Mar. 23, 2022 (NL) 2031386
Mar. 23, 2022 (WO) PCT/EP2022/057683

(51) Int. Cl. B62M 25/04; B62J 50/22; B62M 9/122; B62M 9/132

(52) U.S. Cl. CPC B62M 25/045; B62J 50/22; B62M 9/122; B62M 9/132

(57) ABSTRACT

The disclosure relates to a control module (10) for controlling a plurality of bicycle actuators (20.1, 20.2, 20.3) of a bicycle (1000). The control module (10) comprises a set of a plurality of control programs for controlling the plurality of bicycle actuators (20.1, 20.2, 20.3), and a sensing arrangement (3) configured for detecting a user-actuation thereof, the control module (10) being so arranged that each of the plurality of control programs is selectively activatable and/or deactivatable on a user-actuation of the sensing arrangement (3), wherein the sensing arrangement (3) is configured to be monomanually actuatable by a single hand of a user while bicycling.

### FIELD

The invention relates to a control module for controlling a bicycle actuator of bicycle.

### BACKGROUND

Modern bicycles are provided with various actuators such as for shifting gears. Performance oriented bicycles for example, such as for road racing or mountain biking, typically include two gearshift actuators, i.e. a front derailleur and a rear derailleur. Each gear shift actuator is controlled by a respective shifter at a handlebar of the bicycle, e.g. a left hand shifter for controlling the front derailleur and a right hand shifter for controlling the rear derailleur. Additional actuators can be provided for various other functionalities, such as for lighting, seat post adjustment, etc., wherein the additional actuators include dedicated control buttons for being controlled by a user.

### SUMMARY

It is an aim to provide a control module for facilitating control of multiple bicycle actuators by a user. It is particularly an aim to facilitate a user to control the bicycle actuators while bicycling.

An aspect accordingly provides a control module for controlling a plurality of bicycle actuators of a bicycle. The control module comprises a memory storing a set of a plurality of control programs for controlling the plurality of bicycle actuators, and a sensing arrangement configured for detecting a user-actuation thereof, the control module being so arranged that each of the plurality of control programs is selectively activatable and/or deactivatable on a user-actuation of the sensing arrangement. The sensing arrangement may be configured to be monomanually actuatable by a single hand of a user while bicycling. In particular, the control module may be so arranged that the set of control programs includes all control programs of the bicycle. In particular, the control module may be so arranged that all electronic actuators of the bicycle are controlled through user actuations of the sensing arrangement.

Each control program may control one or more of the bicycle actuators. For example, each control program may be functionally tied to a bicycle actuator, and once activated by a user-actuation of the sensing arrangement, cause the actuator to perform a certain action. The action performed by the actuator is dependent on the actuator itself and the way in which the actuator is controlled using the control program. A control program may for example regulate a power supply to the actuator to have the actuator behave in a desired way. For example, a shift control program may be functionally tied to a shift actuator of the bicycle, e.g. a derailleur, wherein the shift control program, once activated, causes the shift actuator to be powered for a predetermined amount of time to effect a gear shift, e.g. having the actuator shift a chain from one sprocket to another. The predetermined amount of time may be a specific parameter of the shift control program, e.g. corresponding to the indexing of the sprockets. It will be appreciated that a control program may also include more sophisticated control logic, e.g. in which a state of the actuator is sensed and used for feedback.

Some control programs may be activated and deactivated using the sensing arrangement. For example, a front lighting control program for controlling the front light of the bicycle may be activated to turn on the front light, e.g. at a predetermined power setting, and may be deactivated to turn off the front light.

Some control programs may automatically deactivate, and hence may only need activation using the sensing arrangement. For example, an upshift control program for upshifting a transmission may automatically deactivate after execution of the upshift. It will be appreciated that the upshift control program need not be automatically deactivated, such that a manual deactivation using the sensing arrangement may be required. The upshift control program may for example successively upshift until deactivated using the sensing arrangement.

Some control programs may automatically activate, and hence may only need deactivation using the sensing arrangement. For example, the front lighting control program may be activated automatically, for instance in case ambient lightness has decreased below a certain threshold or after a certain threshold time (e.g. at night) to turn on the front light. The front lighting program may hence only may be deactivated using the sensing arrangement, to turn off the front light.

The control module can be configured such that a user can (pre)program the control programs, e.g. using a control app on a mobile device which can be in communication with the control module. The user may store desired control programs, e.g. selected from a provided list, in the memory of the control module.

Optionally, the sensing arrangement is configured for being mounted to a flat-bar handlebar of the bicycle, such as a mountain bike handlebar or a city bike handlebar. A flat-bar handlebar, used for steering, is substantially straight, and extends, in use, substantially parallel to the ground and transverse to a travel direction of the bicycle. A flat-bar handlebar may include a left grip portion and a right grip portion, respectively at a left outer end and a right outer end of the handlebar, configured for being grasped by respectively a left hand and a right hand of the user of the bicycle while cycling.

Optionally, the sensing arrangement is configured to be monomanually operable while holding a handlebar grip portion of the bicycle. The sensing arrangement may thus be configured to be monomanually operable with a single hand while holding a handlebar grip portion of the bicycle with said same single hand. Hence, the sensing arrangement may be arranged at or near, e.g. adjacent to, a grip portion of the handlebar. Optionally, the sensing arrangement is positioned at most 10 cm, more preferably at most 6 cm, from a grip portion of the handlebar. The sensing arrangement may particularly be arranged inside a grip portion, e.g. with respect to the grip portion towards a center of the handlebar.

The control module may for example include a support body for being fixed to or integrated with a handlebar of the bicycle, and a manipulation organ, such as a button, a switch, a rocker switch, a monostable switch, a slider, a rotary switch or a lever, for being manually operable by a user. The manipulation organ is e.g. movable relative to the support body to an actuation position in which the sensing arrangement is actuated. In a particular example, the manipulation organ is embodied as a lever. In a particular example, the manipulation organ is embodied as a button. In a particular example, the manipulation organ is embodied as a rotary button, e.g. a unidirectional rotary button arranged to be manually rotated in a single direction about a rotation axis, or a bi-directional rotary button arranged to be manually rotated in two opposite directions about the rotation axis. The rotation axis may for example coincide with or be parallel with an axis in which the handlebar extends. The rotary button may be an endless rotary button, having no rotation end points. The endless rotatory switch, either unidirectional or bidirectional, may hence be rotated infinitely. The rotary button may alternatively be rotatable between end points, e.g. with or without a return. Further, the actuation positions of the manipulation organ may be indexed, wherein each indexed position is associated with an actuation position, or non-indexed.

It is also possible that the sensing arrangement does not comprise moving parts. The sensing arrangement can e.g. include a touch sensitive element, such as a touch button, e.g. a resistive, capacitive, optical and/or surface acoustic wave touch button. The touch sensitive element can be sensitive to touch motion, such as a touch pad or touch screen, e.g. a resistive, capacitive, optical and/or surface acoustic wave touch pad or touch screen. Touch buttons, touch pads and touch screens are herein also generally referred to as touch switches. Hence, the sensing arrangement can be stationary while motion of e.g. a finger of the user is sensed. Sensing arrangement can e.g. be configured to detect swipes across a surface of the sensing arrangement. A swipe direction can e.g. correspond to activation or deactivation of a control program. The user can e.g. move a virtual slider, e.g. on a touch screen or touch pad, to an actuation position, hence actuating the sensing arrangement.

Optionally, the memory is held by a module housing, and the sensing arrangement is mounted to said module housing. Hence, the memory and the sensing arrangement may share a common module housing. The common module housing may also hold a battery for powering the control module. The common module housing may also hold a processing unit of the control module. The memory, and/or the processing unit may be part of a bicycle computer, e.g. a smartphone, which is detachably connectable to the sensing arrangement.

Optionally, the sensing arrangement is mounted to a first module housing, and the memory is held by a second, separate, module housing, the first and second module housing being arranged for being mounted to a handlebar of the bicycle. Hence, the memory and the sensing arrangement may be associated with separate housings. The memory, e.g. and a processing unit, may for example be arranged at a stem of a bicycle handlebar, whereas the sensing arrangement is arranged at a grip portion of the handlebar.

Optionally, the set of the plurality of control programs comprises a first subset of control programs and a second subset of control programs, and the control module is so arranged that any one of said first subset and second subset is pre-selectable from the plurality of control programs with a pre-selector of the sensing arrangement and any one control program of the pre-selected first or second subset of control programs is activatable and/or deactivatable with an activator of the sensing arrangement. Hence, a user can rapidly navigate through the various control programs by first pre-selecting a subset of control programs, and secondly activating a particular one control program from the pre-selected subset. The sensing arrangement for example comprises a pre-selector switch for pre-selecting any one subset of control programs from the plurality of control programs, and an activator switch for activating and/or deactivating any one control program of said selected subset of control programs. Herein the switches can be mechanical switches, optical switches, magnetic switches, touch switches or the like.

The control module can comprise multiple preconfigured, or preconfigurable subsets of control programs. Each subset of control programs may for example be associated with a respective bicycle actuator. For example, the bicycle may include an electric propulsion motor for propelling, or at least assisting in propelling the bicycle, wherein a subset of e-motor control programs is dedicated to control the electric propulsion motor.

The control module can be configured such that a user can (pre)program the control programs and/or subsets, e.g. using a control app on a mobile device which can be in communication with the control module. The user may store desired subsets and control programs, e.g. selected from a provided list, in the memory of the control module.

Optionally, the bicycle comprising an electric propulsion motor for propelling the bicycle, wherein the control module comprises a subset of power control programs for controlling an output power, and/or level of support, of the electric propulsion motor, wherein said subset includes a power-up control program for increasing a power output, and/or level of support, of the electric propulsion motor and a power-down control program for decreasing the power output, and/or level of support, of the electric propulsion motor. In a simple configuration, the subset of electric propulsion motor control programs for example includes only two control programs: a power-up control program increasing output power, and a power-down program decreasing output power. In another simple configuration, the subset of e-motor control programs for examples includes a plurality, such as three, of control programs, each control program setting a, e.g. predetermined, different power output level, and/or level of support, of the electric propulsion motor.

Optionally, each subset of control programs includes at most two control programs. For example, a subset of gearshift control programs may include an upshift control program for upshifting a transmission to a higher gear, and downshift control program for downshifting the transmission to a lower gear. Some subsets of control programs include more than two control programs. For example, a subset of gearshift control programs may include a first upshift control program for upshifting a transmission to a next higher gear, a first downshift control program for downshifting the transmission to a next lower gear, an second upshift control program for upshifting a transmission to a second next higher gear, and a second downshift control program for downshifting the transmission to a second next lower gear. Some subsets of control programs may include only one control program. The only one control program can for instance be activated and/or deactivated by means of a user-actuation of the activator of the sensing arrangement. For example, a subset of lighting control programs may include only one control program dedicated to turn on the lighting device.

Optionally, the pre-selector is configured for switching between at most two actuation states, hence providing for simple and intuitive single-hand handling by a user. The pre-selector may for example include a first actuation state for pre-selecting a next subset of control programs, and a second actuation state for pre-selecting a previous subset of control programs. The pre-selector may for example include at most two pre-selector switches. Each pre-selector switch may have a single actuation state, such that each pre-selector switch is associated with a respective actuation state of the pre-selector. For example a first pre-selector switch may have the first actuation state of the pre-selector, and the second pre-selector switch may have the second actuation state of the pre-selector. Each pre-selector switch may for example be actuatable through a respective button, or through a common, integrated, button such as a push-button, lever-button, rotary-button or touch button/pad/screen. The button is preferably mono-stable, but it can also be multi-stable. Navigation to a next subset of control programs may be triggered by a user-actuation of the first pre-selector switch, and a navigation to a previous subset of control programs may be triggered by a user-actuation of the second pre-selector switch. The first pre-selector switch and the second pre-selector switch can be integrated into a single switch, such as a single button.

The pre-selector may also include only one actuation state for example for cyclically pre-selecting each of control programs in a consecutive order. Hence, in a particular simple setup, the pre-selector for example has only one pre-selector switch.

Optionally, the activator is configured for switching between at most two actuation states. However, in some examples, the activator is configured for switching between more than two states. The activator may for example include a first actuation state for activating a first control program of the pre-selected subset of control programs, and a second actuation state for activating a second control program of the pre-selected subset of control programs. The activator may for example include at most two activator switches. In some examples, the activator may include more than two switches. Each activator switch may have a single actuation state, such that each activator switch is associated with a respective actuation state of the activator. For example a first activator switch may have the first actuation state of the activator, and the second activator switch may have the second actuation state of the activator. Each activator switch may for example be actuatable through a respective button, or through a common, integrated, button. Execution of a first control program of a pre-selected subset of control programs may be triggered by a user-actuation of the first activator switch, and an execution of a second control program of said subset may be triggered by a user-actuation of the second activator switch. In a particular example, a third control program of said pre-selected subset may be triggered for instance by a simultaneous user-actuation of the first and the second activator switch.

The activator may also include only one actuation state for example for activating each of control programs consecutively. Hence, in a particular simple setup, the activator for example has only one activator switch. The activator switch may be actuatable through a button, such as a push-button, lever-button, rotary-button or touch button. The button is preferably monostable, but it can also be multi-stable.

Optionally, at least one pre-selector switch and at least one activator switch are integrated, e.g. in a single button. Optionally, all pre-selector switches and all activator switches are integrated, e.g. in a single button.

The pre-selector and/or the activator may be integrated with a brake-lever of the bicycle. For example, a pre-selector switch may be actuatable by pivoting the brake lever in a pivot direction transverse to a pivot direction for activating the brakes. For example, the control may comprise a support body for being fixed to or integrated with a handlebar of the bicycle and a lever movably arranged relative to the support body for being manually operable by a user, wherein the lever is movable relative to the support body in a first direction to a braking position for activating a braking action, and wherein the manipulation organ is further movable relative to the support body in second, different, direction to an actuation position for actuating the sensing arrangement.

Optionally, the control module comprises an confirmator for confirming a pre-selection of a subset of control programs. Hence, a confirmation step may be required before effectuating a pre-selection. This allows a user to remain in control of an active subset of control programs, e.g. to activate gear shift control programs, whilst navigating to another subset of control programs, e.g. to control bicycle lighting. The confirmator preferably has only actuation state.

Optionally, the pre-selector and the confirmator are integrated into a single button, for providing particular simple and compact setup. For example, the single button may include a lever-function and push-function, wherein, e.g. a subset of control programs is pre-selected using the lever-function, and confirmed using the push-function of the button.

Optionally, the sensing arrangement is so configured that the pre-selector and the confirmator are monomanually actuatable with only one finger, particularly a thumb. Optionally, the pre-selector and the confirmator are integrated into a single button.

Optionally, the control module comprises one or more sensors for sensing a state of the bicycle, its user, and/or its environment, wherein a subset of control programs is automatically pre-selectable based on the sensed state. The control module may for example comprise control logic for automatically changing the pre-selected control program based on the detected state of the bicycle, user and/or its environment. For example, the control module may comprise a speed sensor for measuring a speed of the bicycle, a power sensor for measuring an input power to the transmission, a positioning system for measuring a geographical position of the bicycle, a heart rate sensor for measuring a heart rate of the user, a temperature sensor for measuring an ambient temperature, etc. Based on sensor data obtained from the one or more sensors, an appropriate subset of control programs can be automatically pre-selected, such that the user can immediately activate and/or deactivate a control program from the automatically pre-selected subset of control programs. For example, a subset of bail-out gearshift control programs may be automatically pre-selected, in case it is detected that the user approaches a steep ascent, such that the user can immediately choose to activate e.g. a control program for rapidly shifting, e.g. with relatively large steps, to an easier gear.

Optionally, the control module comprises a subset of brake control programs, configured for controlling a brake actuator of the bicycle. The brake actuator, e.g. a brake caliper, may apply a brake force, e.g. on a brake disc coupled to a bicycle wheel, for reducing a speed of the bicycle. The subset of brake control programs may for example comprise a brake force increasing control program for increasing a brake force, and a brake force decreasing control program for decreasing a brake force. The subset of brake control programs may for example also comprise multiple brake force setting control programs for applying a fixed, e.g. predefined, or velocity dependent, brake force. Each brake force setting control program may set a different brake force.

Optionally, the control module comprises a brake sensor configured for measuring a brake organ, e.g. brake lever, position, e.g. relative to a base member or to a handlebar, wherein a brake control program of the subset of brake control programs is activated dependent on the measured brake organ position.

Optionally, the control module comprises a default subset of control programs, wherein the control module is so configured that the default subset of control programs is automatically pre-selected upon detection of a predefined elapsed time period of inactivity of the sensing arrangement and/or upon detection of an activation of a control program. The control module may for example be configured such that after a user has preselected a subset of control programs, the control module automatically reverts to the default subset of control programs. For instance, control logic of the control module may detect an activation of a control program by the user, and, upon detection of the activation, automatically reverts to the default subset of control programs. Also, the control module may be configured to detect a lapse of a predetermined amount of time, e.g. 3 seconds, from a last user-actuation of the sensing arrangement, and may upon detection of the inactivity for at least this time period, automatically revert to the default subset the control programs.

The default subset of control programs can be selectable by a user. The control module can be configured such that the default subset can be chosen, e.g. preprogramed, by a user, e.g. using a control app on a mobile device which can be in communication with the control module. The default subset of control programs may for example be preselected to relate to gear shifting. Hence, the control module may automatically return to the default subset of gearshift programs, e.g. after having turned on the lights of the bicycle via a subset of lighting control programs.

Optionally, the sensing arrangement is configured for being actuatable by at most two fingers of a single hand of a user while bicycling, for example by an index finger and thumb of a single hand. The pre-selector, and optionally the confirmator, may for example be actuated by the thumb, and the activator by the index finger.

Optionally, the control module comprises a visual feedback device configured for providing visual feedback to a user of currently pre-selected subset of control program, and/or an activation state of said currently pre-selected subset of control programs. The visual feedback device may for example include a display, e.g. an LCD, a touch screen, and/or multiple LED's and/or back lit icons, showing the user visually, e.g. the available (subsets of) control programs, the currently pre-selected subset and the activation state of the current control program. The visual feedback device mounted to, or integrated with, the common module housing. The visual feedback device may also be formed by a bicycle computer, such as smartphone or tablet, which is connected to the sensing arrangement.

Optionally, the control module comprises a haptic feedback device configured for providing haptic feedback to a user of the currently pre-selected subset of control programs, and/or an activation state of said currently pre-selected subset of control programs. The haptic feedback device may for example be configured for giving tactile feedback to a user operating the bicycle.

Optionally, the control module comprises an audio feedback device configured for providing auditory feedback to a user of the currently pre-selected subset of control programs, and/or an activation state of said currently pre-selected subset of control programs.

Optionally, the control module comprises one or more of a subset of gearshift control programs, a subset of lighting control programs, a subset of seat post adjustment control programs, a subset of suspension adjustment control programs, a subset of auxiliary propulsion power control programs, a subset of horn control programs, a subset of indicator control programs, and a subset of regenerative braking control programs. Each subset may for example include at most two control programs, e.g. a control program to increase, and a control program to decrease. Some subsets may for example include a single control program that is activatable and/or deactivatable, e.g. using the activator. For example a subset may include a suspension lock control program to lock a suspension of the bicycle, wherein the suspension lock program can be activated to lock the suspension and deactivated to unlock the suspension.

Optionally, the bicycle comprises a transmission and a gearshift actuator for shifting gears of the transmission, and the control module comprises an upshift control program for, with the gearshift actuator, upshifting to a higher gear and/or a downshift control program for, with the gearshift actuator, downshifting to a lower gear. The control module for example comprises a subset of control programs which subset includes the upshift control program and the downshift control program, wherein the control module is so configured that said subset of control programs is pre-selectable from the plurality of control programs with the pre-selector and that the upshift control program or the downshift control program is activatable with the activator from said pre-selected subset of control programs.

Optionally, the bicycle comprises a transmission having a first gearshift actuator and a second gearshift actuator for shifting gears of the transmission, and wherein the control module comprises a first subset of control programs for controlling only the first gear shift actuator and a second subset of control programs for controlling only the second gear shift actuator.

Optionally, the first subset includes a first upshift control program and first downshift control program for controlling the first gearshift actuator to respectively upshift and downshift, and the second subset includes a second upshift control program and a second downshift control program for controlling the second gearshift actuator to respectively upshift and downshift. The control module is for example so configured that the first subset of control programs or the second subset of control programs is pre-selectable from the plurality of control programs with the pre-selector and that the first upshift control program or the first downshift control program is activatable with the activator from the pre-selected first subset or that the second upshift control program or the second downshift control program is activatable with the activator from the pre-selected second subset.

Optionally, the bicycle comprises a transmission having one or more gear selection actuators for selecting any one of a plurality of gears of the transmission, and the control module comprises a subset of automatic gear selection control programs, said subset including an automatic gear selection control program configured for automatically selecting a gear of the transmission dependent on a measured state of the bicycle. The bicycle state may include one or more bicycle state parameters of a speed of the bicycle, a cadence of a crank of the bicycle, a geographic location of the bicycle, a torque or power input, e.g. to the crank of the bicycle, physiologic parameters of a user of the bicycle, e.g. heart rate. Hence, the bicycle state may include parameters associated with bicycle hardware components, and/or parameters associated with an environment of the bicycle, and/or parameters associated with a user of the bicycle. The automatic gear selection control program may for example be activated or deactivated using the activator. When activated, the automatic gear selection control program can automatically control gearshift actuators of the bicycle transmission to change gears without requiring a user request. Instead of a user request, the automatic gear selection control program can automatically change gears of the transmission, particularly to track a preset bicycle state. The automatic gear selection can be performed such that a predefined one, or predefined combination, of bicycle state parameters is approximated as closely as possible. In addition to the automatic gear selection, manual user-requested gear selection may nonetheless be accepted.

The subset of automatic gear selection control programs may particularly track, i.e. monitor and adjust gear selection to maintain, a preset bicycle state, such as a cadence setpoint, and/or a heartrate setpoint. The preset bicycle state may be chosen by a user, and may for instance be programmed and adapted. The transmission may for example be operated to automatically select a gear, e.g. based on a current velocity of the bicycle, at which a crank cadence closest matches a preset desired crank cadence. Hence, a user may always cycle at an at least approximately constant cadence.

Optionally, the control module comprises a subset of semi-automatic gear selection control programs, said subset including a semi-automatic gear selection control program configured for automatically selecting a gear of the transmission in case a measured bicycle state exceeds a predefined boundary state. The semi-automatic gear selection control program allows a user to manually change gears within a range of bicycle states, wherein gears are only automatically changed, to a more appropriate gear, in case the bicycle state exceeds the preset boundary state. For example, in case a measured crank cadence is very low, i.e. below a preset lower boundary value, an automatic gear change is triggered to increase the crank cadence. The semi-automatic gear selection control program may hence be used to avoid extremes.

Optionally, the control module comprises a subset of manual gear selection control programs, said subset including a manual gear selection control program configured for selecting a gear of the transmission, e.g. only, based on a user-request. When activated, the manual gear selection control program allows a user to manually select an appropriate gear of the bicycle transmission, e.g. by manually operating a shifter device.

Optionally, the bicycle comprises a transmission having a first gearshift actuator and a second gearshift actuator for shifting gears of the transmission, and the control module comprises a subset of synchronous gearshift control programs, said subset including an synchronous upshift control program and a synchronous downshift control program configured for selectively shifting the first or the second gearshift actuator, and for simultaneously shifting the first and the second gearshift actuator, to respectively upshift or downshift the transmission. In some instances, an upshift of the transmission may require, e.g., an upshift with the first gearshift actuator and a downshift with the second gear shift actuator. Shifting can hence be simplified for a user, since the user can simply request an upshift or downshift, wherein the first and/or second gearshift actuators are accordingly controlled to upshift or downshift. The control module is for example so configured that the subset of synchronous gearshift control programs is pre-selectable from the plurality of control programs with the pre-selector and that the synchronous upshift control program or the synchronous downshift control program is activatable with the activator.

Optionally, the control module is configured to detect an actuation time duration of the sensing arrangement, and activate a control program in dependence of the detected actuation time duration. For example, in case a subset of gearshift control programs is pre-selected, a relatively short actuation of the activation may cause a relatively small gear change whereas a relatively long actuation of the activation may cause a relatively large gear change.

Optionally, the control module is configured to detect an actuation pressure of the sensing arrangement, and activate a control program in dependence of the detected actuation pressure. Optionally, the control module is configured to detect an actuation time duration of the sensing arrangement, and activate a control program in dependence of the detected actuation time duration.

Optionally, the control module is configured to detect an intermediate time period between consecutive actuations, and activate a control program in dependence of the detected intermediate time period. For example, in case a subset of gearshift control programs is pre-selected, a single actuation of the activation within a predefined time period may cause a relatively small gear change whereas multiple successive actuations of the activation with the predefined time-frame may cause a relatively large gear change. The control module may for example be configured to distinguish between a different sequences of successive actuations of the activator, and activate or deactivate a control program accordingly.

According to a further aspect, a control system for controlling a plurality of bicycle actuators of a bicycle is provided. The control system comprises a memory storing a set of a plurality of control programs for controlling the plurality of bicycle actuators. The control system comprises a first control module having a left sensing arrangement configured to be, e.g. monomanually, actuatable by a left hand of a user while bicycling. The control system comprises a second control module having a right sensing arrangement configured to be, e.g. monomanually, actuatable by a right hand of a user while bicycling. The control system is so arranged that each of the plurality of control programs is selectively activatable and/or deactivatable on a user-actuation of the sensing arrangements.

The set of the plurality of control programs can comprise a first subset of control programs and a second subset of control programs. The control system can be so arranged that any one of said first subset and second subset is pre-selectable from the plurality of control programs with a pre-selector of the left and right sensing arrangements, and that any one control program of the pre-selected first or second subset of control programs is activatable and/or deactivatable with an activator of the left and right sensing arrangements. The first control module can include the pre-selector and the second control module the activator, or the second control module can include the pre-selector and the first control module the activator.

The control system can comprise a first control module as described herein, the sensing arrangement of which being configured to be monomanually actuatable by a left hand of a user while bicycling. The control system can further comprise a second control module as described herein, the sensing arrangement of which being configured to be monomanually actuatable by a right hand of a user while bicycling. The control system may be so configured that each of the control modules can activate all control programs of the control system. Hence, a user may setup the control system to his preference; e.g. a righthanded user may prefer to shift gears using his/her right hand, while with his/her left hand the user can operate additional actuators, such as an electric auxiliary power source for additional propulsion. It will be appreciated that the first and second control modules need not be identical. Optionally, the first control module includes only a first one of a pre-selector and an activator, and the second control module includes only a second, different, one of the pre-selector and activator. For example, the first control module only includes a pre-selector for preselecting a subset of control programs, and the second control module only includes an activator for activating a control program from the preselected subset, or vice versa. Hence, a user can for instance use his/her left hand for pre-selecting a desired subset of control programs, and his/her right hand for activating a desired control program from the preselected subset, or vice versa.

In an example, the first and second control modules are the same or mirrored with respect to each other to be intuitively operated by a respective left and right hand. The first and second control modules may share a common feedback device, such as a common display. The first and second control modules may also share a common processing unit. The feedback device, and/or the processing unit, may for example be formed by a bicycle computer.

The first control module may be configured to activate two different control programs, e.g. a first control program and a second control program. For example, the activator of the first control module, which may be referred to as the first activator, may for example include two actuation states: a first actuation state for activating the first control program of the pre-selected subset of control programs, and a second actuation state for activating the second control program of the pre-selected subset of control programs.

Similarly, the second control module may be configured to activate a further two different control programs, e.g. a third control program and a fourth control program. For example, the activator of the second control module, which may be referred to as the second activator, may include two actuation states: a third actuation state for activating the third control program of the pre-selected subset of control programs, and a fourth actuation state for activating the fourth control program of the pre-selected subset of control programs.

Further, the first control module may be configured to pre-select two different subsets of control programs, e.g. a first subset and a second subset. For example, the pre-selector of the first control module, which may be referred to as the first pre-selector, may for example include two actuation states: a first actuation state for pre-selecting a first subset of control programs, and a second actuation state for pre-selecting a second subset of control programs. The second control module may similarly be configured to pre-select a further two different subset of control programs, e.g. a third subset and a fourth subset. For example, the pre-selector of the second control module, which may be referred to as the second pre-selector, may include two actuation states: a first actuation state for pre-selecting the third subset of control programs, and a second actuation state for pre-selecting the fourth subset of control programs.

In conjunction, the first control module and the second control module may be configured to pre-select more than four subsets of control programs, and/or activate more than four control programs from a preselected subset.

Optionally, the control system is arranged to preselect a fifth subset of control programs when both the first pre-selector and the second pre-selector are in their respective first actuation states. Optionally, the control system is arranged to activate a fifth control program from a preselected subset of control programs when both the first activator and the second activator are in their respective first actuation states.

Optionally, the control system is arranged to preselect a sixth subset of control programs when the first pre-selector is in its second actuation state and the second pre-selector is in its first actuation state. Optionally, the control system is arranged to activate a sixth control program from a preselected subset of control programs when the first activator is in its second actuation state and the second activator is in its first actuation state.

Optionally, the control system is arranged to preselect a seventh subset of control programs when the first pre-selector is in its first actuation state and the second pre-selector is in its second actuation state. Optionally, the control system is arranged to activate a seventh control program from a preselected subset of control programs when the first activator is in its first actuation state and the second activator is in its second actuation state.

Optionally, the control system is arranged to preselect an eighth subset of control programs when both the first pre-selector and the second pre-selector are in their respective second actuation states. Optionally, the control system is arranged to execute an eighth control program from a preselected subset of control programs when both the first activator and the second activator are in their respective second actuation states.

Optionally, the control system is arranged to preselect a ninth subset of control programs when both the first pre-selector and the second pre-selector are in their respective neutrals. Optionally, the control system is arranged to activate a ninth control program from a preselected subset of control programs when both the first activator and the second activator are in their respective second actuation states.

To enable a user to independently preselect, activate, and/or deactivate any of the control programs, the activation may be made dependent on the actuation time, i.e. the time duration the sensing arrangement is actuated. The sensing arrangement may accordingly be arranged to detect a time duration of actuation. For example, the sensing arrangement may be arranged to detect an actuation state and the time duration at which the actuation state is maintained. The control system may be accordingly arranged to execute or not execute a control program dependent on said detected time. Further, the execution of a control program may be depending on a current or previous actuation state.

Optionally, the control system comprises a common memory, the first control module and the second control module being connected to the common memory.

Optionally, the control system comprises a common processing unit, the first control module and the second control module being connected to the common processing unit.

Another aspect provides a handlebar for a bicycle, particularly a flat-bar handlebar such as for a mountain bike, or a city bike handlebar. The handlebar comprises a control module as described herein, or a control system as described herein wherein the first control module is arranged at a left hand grip portion of the handlebar, and the second control module is arranged at a right hand grip portion of the handlebar. The control module(s) may for instance be, at least partly, integrated with the handlebar.

An aspect further provides a method for controlling a plurality of bicycle actuators of a bicycle, comprising providing a control module or control system as described herein, and pre-selecting any one subset of control programs from the plurality of control programs activating and/or deactivating any one control program of said pre-selected one subset of control programs. The method optionally includes after pre-selecting any one subset of control programs, and before activating and/or deactivating any one control program from said pre-selected one subset, confirming the pre-selection, e.g. by actuating a confirmator switch.

A bicycle is provided in a further aspect, comprising a control module as described herein. It will be appreciated that a bicycle encompasses similar human-powered vehicles, particularly pedal-powered, such as tricycles, quadricycles, etc.

It will be appreciated that any of the aspects, features and options described herein can be combined. It will particularly be appreciated that any of the aspects, features and options described in view of the control module apply equally to the control system, handlebar and bicycle, and vice versa. It will also be appreciated that any of aspects, features and options descried in view of the control module apply equally to the method, and vice versa.

### BRIEF DESCRIPTION OF THE DRAWINGS

Embodiments of the present invention will now be described in detail with reference to the accompanying drawings in which:

FIGS. 1-6 show schematic examples of a control module;

FIG. 7 shows a control system;

FIG. 8 shows a control system;

FIGS. 9A, 9B, 9C show a handlebar for a bicycle;

FIG. 10 shows a handlebar for a bicycle;

FIGS. 11A-11C and 12A-12C show an integrated control module;

FIG. 13 shows an exemplary schematic of pre-selectable subsets and associated activatable control programs

FIG. 14A shows an exemplary schematic of activatable control programs;

FIG. 14B show an exemplary schematic of pre-selectable subsets of control programs;

FIG. 15 shows a bicycle.

### DETAILED DESCRIPTION

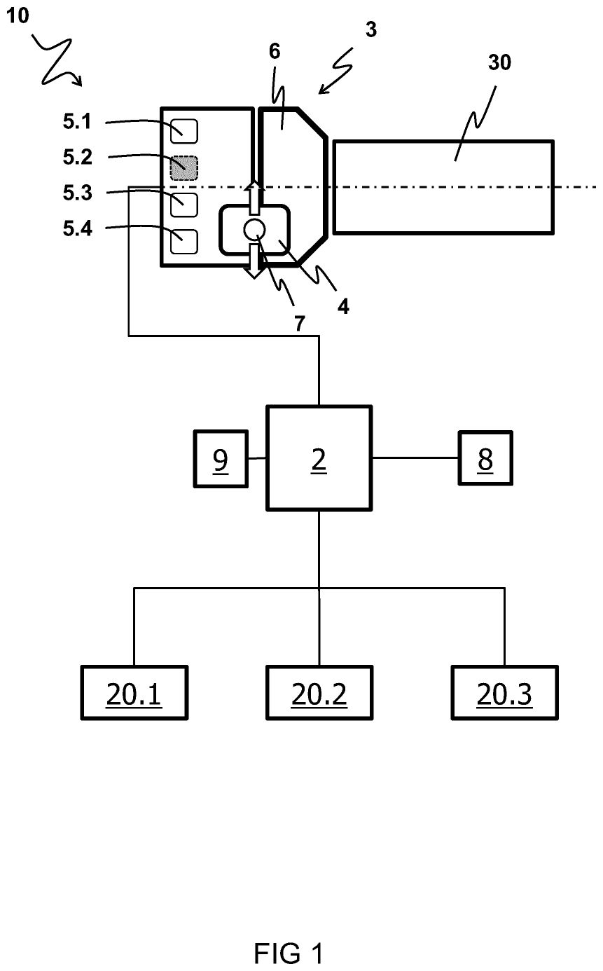

FIG. 1 shows an example of a control module 10. The control module 10 comprises a processing unit 2 having a memory 9 that stores a plurality of control programs for controlling various bicycle actuators 20.i, here three bicycle actuators 20.1, 20.2, 20.3 are schematically shown. The plurality of control programs may be divided into subsets of control programs, each subset including one or more control programs. Each subset may for example be unique. For ease of use, each subset of control programs may include at most two control programs.

The processing unit 2 is in this example connected to all bicycle actuators 20.i directly, in particular wirelessly, but it will be appreciated that other connection schemes are also possible. Each bicycle actuator may be controlled by one or more control programs. Each bicycle actuator may particularly have at least one subset of control programs associated therewith.

The control module 10 also comprises a sensing arrangement 3 for being actuated by a user, in this example by a single hand of the user. The sensing arrangement 3 may include one or more switches for being actuated by a user by means of one or more buttons. Herein the switches can be mechanical switches, optical switches, magnetic switches, touch switches or the like. In these examples, the sensing arrangement is configured to be mounted to a bicycle handlebar, particularly a flat bar or city bar. In these examples, the sensing arrangement is not mounted to a drop type handlebar. In these examples, the sensing arrangement 3 is provided at a right grip portion 30 of a bicycle handlebar, such that the sensing arrangement 3 is monomanually operable using only the user's right hand, while bicycling. This sensing arrangement is monomanually operable while holding the grip portion of the handlebar. The sensing arrangement 3 is connected to the processing unit 2, e.g. wiredly. The sensing arrangement 3 is arranged to detect a user-actuation thereof by the user, and to transmit a signal to the processing unit 2 upon detection of a user-actuation. The processing unit 2 in turn selectively controls one or more of the bicycle actuators 20.i accordingly.

The processing unit 2, and memory 9, may be part of a bicycle computer, e.g. a smartphone, wherein the bicycle computer is detachably connectable to the sensing arrangement. The processing unit 2 is in this example a junction that is connected to the sensing arrangement 3 as well as to the bicycle actuators 20.1, 20.2, 20.3. The processing unit 2 may hence receive signals from the sensing arrangement 3, process those signals and transmit signals to the actuators 20.1, 20.2, 20.3, particularly in accordance with a control program stored in the memory 9.

The sensing arrangement 3 includes a pre-selector 4 for pre-selecting a preconfigured subset of control programs from the plurality of control programs. The pre-selector 4, in the example of FIG. 1, includes two actuation states, one state for switching to a next subset of control programs, and another state for switching to a previous subset of control programs. In this example, the user can manually move a slider-button to navigate through the preconfigured subsets, in this case upwardly to pre-select a next subset and downwardly to pre-select a previous subset, as indicated by the arrows. A current preselection is indicated by a visual feedback device 5, here including four lights 5.1-5.4 representing four different subsets of control programs. In an alternative example, the feedback device may include a single light arranged for emitting different colors, wherein different subsets of control programs are visually indicated by the different colors of the light. Each subset may hence, for example, be associated with a respective colour.

The sensing arrangement 3 also comprises an activator 6 for activating a particular control program in the pre-selected subset of control programs. The activator 6, here, includes two actuation states, a first state for activating a first control program of the pre-selected subset, and a second state for activating a second control program of the pre-selected subset. In the example of FIG. 1, the user can manually rotate a rotary-button 6 about an axis A that corresponds to a center axis of the grip portion 30. In this case, clockwise rotation of the rotary button activates the first control program and a counter clockwise rotation of the rotary button activates the second control program. In case a pre-selected subset includes a single control program, the control module may be so configured that any rotation direction activates and/or deactivates the single control program.

The rotary button may be a unidirectional rotary button arranged to be manually rotated in a single direction about a rotation axis, or a bi-directional rotary button arranged to be manually rotated in two opposite directions about the rotation axis. The rotary button may be an endless rotary switch, having no rotation end points. The endless rotatory button, either unidirectional or bidirectional, may hence be rotated infinitely. The rotary switch may alternatively be rotatable between end points, e.g. with or without an automatic (e.g. biased) return to neutral. Further, the actuation positions of the manipulation organ may be indexed, wherein each indexed position is associated with an actuation state, or non-indexed.

In this example, the pre-selector 4 and activator 6 are positioned such that they can be operated by the user, while holding the grip portion of the handlebar, e.g. using a thumb, index finger or ring finger. Preferable the pre-selector and activator are positioned less than 10 cm, more preferably less than 6 cm, from the gripping portion of the handlebar.

In the example of FIG. 1, the sensing arrangement also comprises a confirmator 7, for confirming a pre-selection made with the pre-selector. The confirmator 7 can be omitted if desired. The confirmator 7 has in this example a single actuation state, and is actuatable by a push-button. Here the pre-selector and the confirmatory are integrated into a single slider-push-button wherein a slider-function of the button can be used for pre-selecting a subset and the push-function for confirming a pre-selection.

The control module 10 can also comprise a sensor 8, which is connected to the processing unit 2. The sensor 8 is arranged for measuring a state of the bicycle, the user, and/or its environment. The sensor 8 transmits a sensor signal to the processing unit 2, indicative of a state of the bicycle, user and/or environment. The processing unit 2 can include control logic to automatically pre-select an appropriate subset of control programs based on the received sensor signal.

It will be appreciated that the processing unit 2 can include a processor, i.e. hardware configured to execute the control programs. The processor may for example be an arithmetic processor that runs the control programs stored in the memory 9. The processor can be a central processing unit (CPU) or a micro processing unit (MPU). The processor can be formed of one or more semiconductor chips that are mounted on a circuit board that includes the memory 9. The memory 9 may be any computer storage device or any non-transitory computer-readable medium, e.g. with the sole exception of a transitory, propagating signal. For example, the memory 9 can include nonvolatile memory and volatile memory, and can includes a ROM (Read Only Memory) device, a RAM (Random Access Memory) device, a hard disk, a flash drive, etc.

The control module 10 in these examples comprises four subsets of control programs, indicated by lights 5.1-5.4, but it will be appreciated that the control module 10 may include more than four or less than four subsets. The control module can particularly include a first subset of gearshift control programs for controlling a first gearshift actuator, e.g. a rear derailleur, and a second subset of gearshift control programs for controlling a second gearshift actuator, e.g. a front derailleur. Each of the first and second subsets includes an upshift and a downshift control program. Hence, a user can operate the front derailleur and the rear derailleur independently with a single hand, in this case its right hand. Alternatively, a first subset of gearshift control programs relates to controlling a rear derailleur, and a second subset of gearshift control programs relates to controlling a hub or crank gear shift device. Alternatively, a first subset of gearshift control programs relates to controlling a first actuator of a hub or crank gear shift device, and a second subset of gearshift control programs relates to controlling a second actuator of a hub or crank gear shift device.

The control module, here, also comprises a third subset of gearshift control programs for synchronised shifting gears with selectively the first gearshift actuator and/or the second gearshift actuator. For instance, in view of a current gear, a next-higher gear of the transmission may require a conjunctive downshift with the first gearshift actuator and a upshift with the second gearshift actuator. An synchronised upshift control program of the third subset may accordingly operate the first and second gear shift actuators synchronously. In view of another gear, a next-higher gear of the transmission may require only an upshift with the first gearshift actuator. The synchronised upshift control program controls the first and second actuators accordingly.

A fourth subset of control programs may be one or more of a subset of saddle height control programs, subset of lighting control programs, a subset of suspension adjustment control programs, a subset of auxiliary propulsion power control programs, and a subset of regenerative braking control programs, etc.

It will be appreciated that many distributions of subsets of control programs are conceivable. An alternative distribution can e.g. include a first subset of control programs associated with gear shifting. The first subset can e.g. include a first control program for shifting to the next higher gear. The first control program can be configured to shift a first gearshift actuator, such as a rear derailleur, and/or a second gearshift device, such as a front derailleur or hub shift device, as required for achieving the next higher gear. The first subset can e.g. include a second control program for shifting to the next lower gear. The second control program can be configured to shift the first gearshift actuator, such as the rear derailleur, and/or the second gearshift device, such as the front derailleur or hub shift device, as required for achieving the next lower gear. The second subset of control programs can e.g. relate to lighting control programs. The third subset of control programs can e.g. relate to suspension adjustment control programs. The fourth subset of control programs can e.g. relate to auxiliary propulsion power control. The control module 10 can be configured such that the availability and order in which the subsets can be selected is configurable by a user, e.g. using a control app on a mobile device which can be in communication with the control module 10.

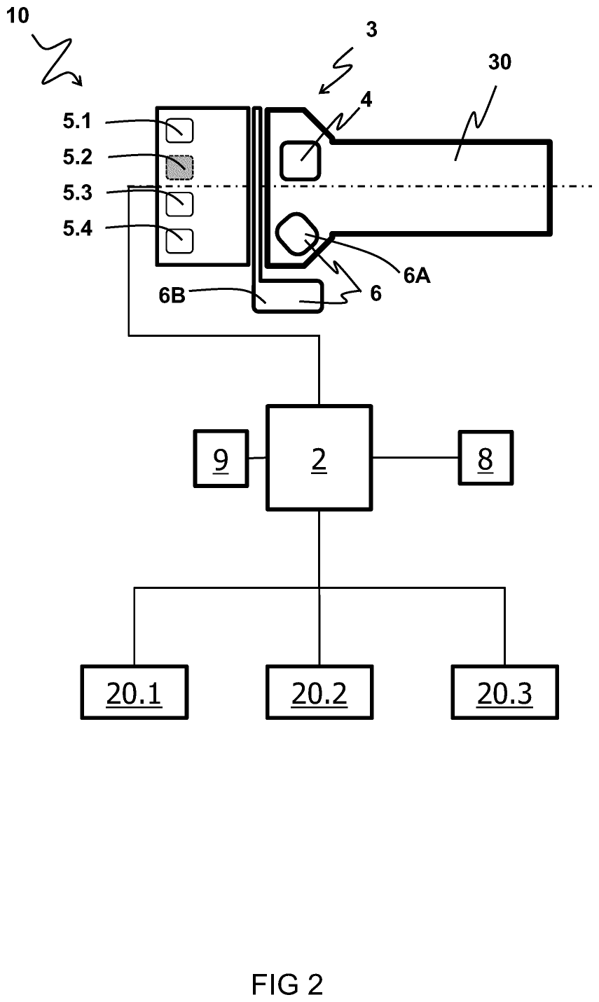

In the example of FIG. 2, the pre-selector 4 includes a single actuation state. Here, a user can cycle through the preconfigured subsets in a consecutive order by pressing a push-button 4 to switch to a next subset. In this example, the activator 6 comprises 2 two push-buttons 6A, 6B. The user can manually press a first push-button 6A for activating the first control program, and manually press a second button 6B, which in this example translates into a rotary motion about the axis A, to activate the second control program.

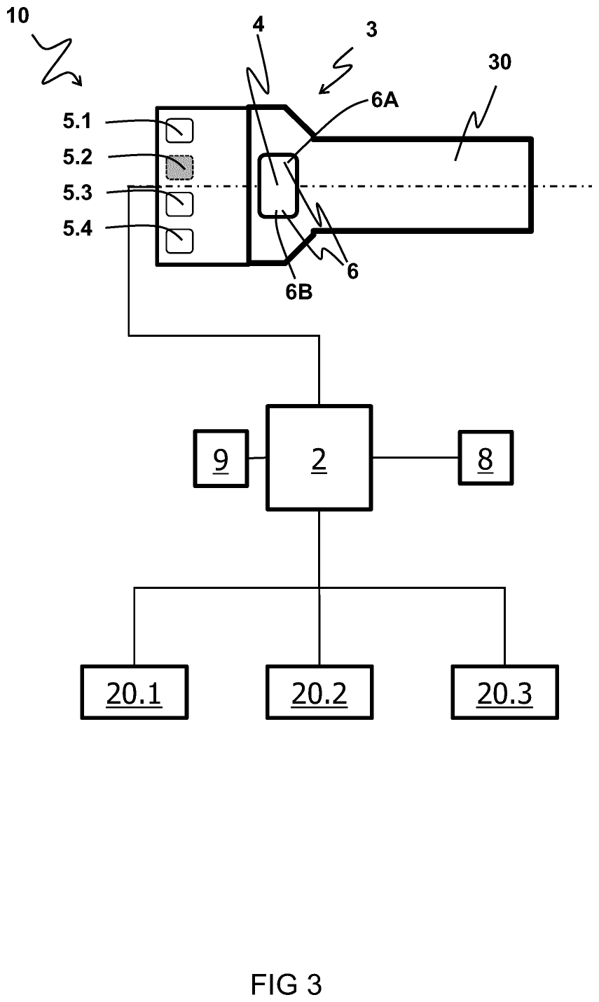

In the example of FIG. 3, the pre-selector 4 and the activator 6 are integrated into a single interface device, here a button. The single interface device includes multiple switches. A first switch 4 senses depressing of the button as a whole, and acts as the pre-selector 4 to cycle through the preconfigured subsets in a consecutive order. A second switch senses depressing of a top end of the button, and acts as a first push-button 6A of the activator 6 for activating the first control program. A third switch senses depressing of a lower end of the button, and acts as a second push-button 6B of the activator 6 for activating the second control program.

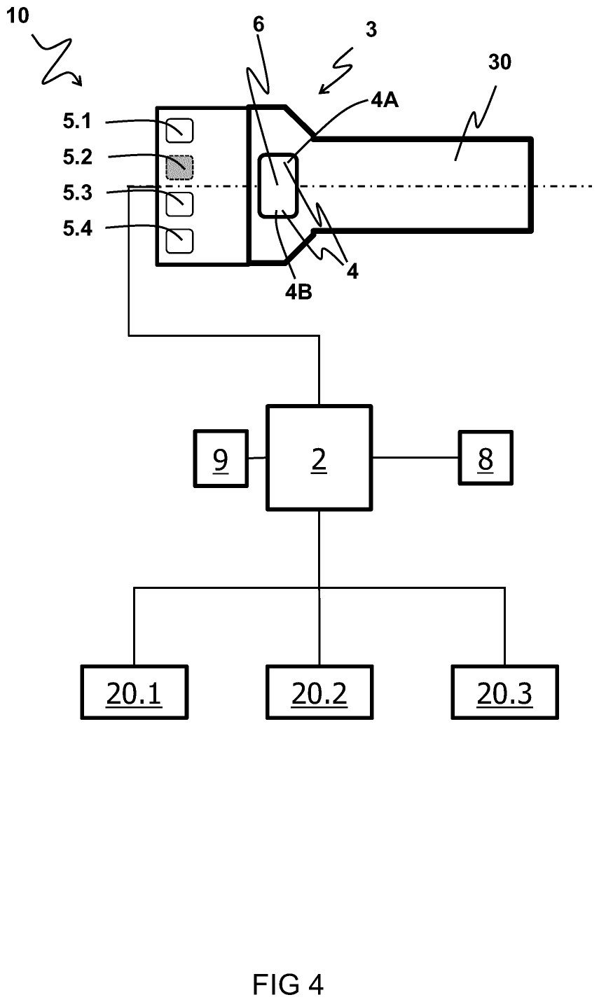

In the example of FIG. 4, the pre-selector 4 and the activator 6 are integrated into a single interface device, here a button. The single interface device includes multiple switches. A first switch senses depressing of a top end of the button, and acts as a first push-button 4A of the pre-selector 4 to navigate through the preconfigured subsets, in this case upwardly to pre-select a next subset. A second switch senses depressing of a lower end of the button, and acts as a second push-button 4B of the pre-selector 4 to navigate through the preconfigured subsets, in this case downwardly to pre-select a next subset. A third switch senses depressing of the button as a whole, and acts as a push-button of the activator 6 for activating the first control program or the second control program. The first and second control programs can e.g. be toggled by depressing the push-button of the activator, i.e. repeated pressing of the push-button can alternate activation of the first and second control program. Alternatively, different depressing modes can activate the first and second control programs. For example briefly depressing the push-button (e.g. shorter than a threshold time) can activate the first control program, while longer depressing the push-button (e.g. longer than the threshold time) can activate the second control program. Alternatively singly depressing the push-button (single-click) can activate the first control program, while doubly depressing the push-button (double-click) can activate the second control program.

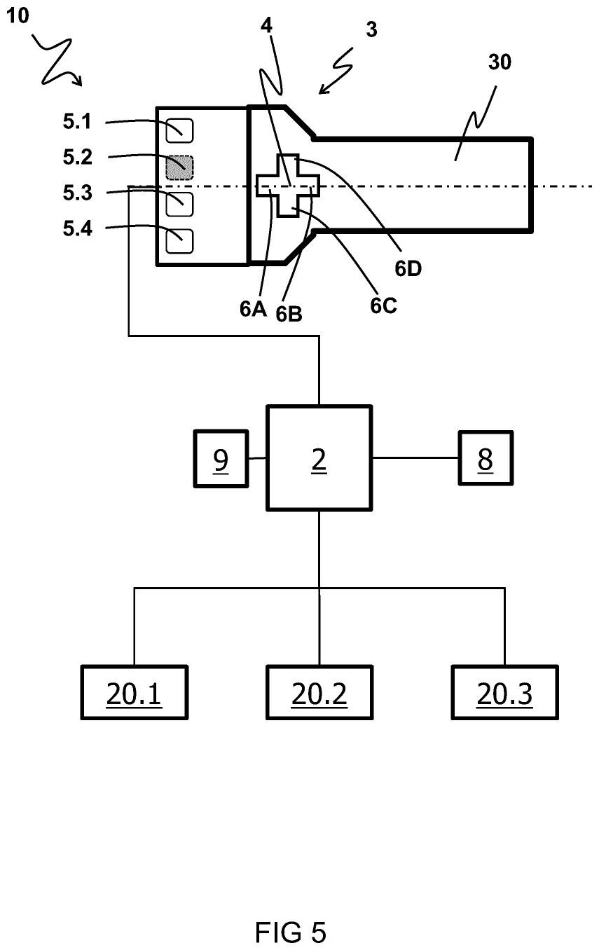

In the example of FIG. 5, the pre-selector 4 and the activator 6 are integrated into a single interface device, here a button. The single interface device includes multiple switches. A first switch 4 senses depressing of the button as a whole, and acts as the pre-selector 4 to cycle through the preconfigured subsets in a consecutive order. A second switch senses depressing of a left end of the button, and acts as a first push-button 6A of the activator 6 for activating the first control program. A third switch senses depressing of a right end of the button, and acts as a second push-button 6B of the activator 6 for activating the second control program. In this example, a fourth switch senses depressing of a top end of the button, and acts as a third push-button 6C of the activator 6 for activating a third control program. A fifth switch senses depressing of a lower end of the button, and acts as a fourth push-button 6D of the activator 6 for activating the fourth control program. In this example, the first, second, third and fourth control programs may relate to the same subset. For instance, in a subset of gearshift control programs, the first control program can relate to controlling a first gearshift actuator, e.g. a rear derailleur, to shift down; the second control program can relate to controlling the first gearshift actuator, e.g. the rear derailleur, to shift up; the third control program can relate to controlling a second gearshift actuator, e.g. a front or hub derailleur, to shift down; and the fourth control program can relate to controlling the second gearshift actuator, e.g. the front or hub derailleur, to shift up. Alternatively, for instance, in a subset of gearshift control programs, the first control program can relate to controlling a system gear ratio to shift down one step; the second control program can relate to controlling the system gear ratio to shift up one step; the third control program can relate to controlling the system gear ratio to shift down multiple, e.g. two, steps; and the fourth control program can relate to controlling the system gear ratio to shift up multiple, e.g. two, steps. Alternatively, for instance, the first control program can relate to activating a first control program associated with the subset selected by the pre-selector 4; the second control program can relate to activating a second control program associated with the subset selected by the pre-selector 4; the third control program can relate to activating a first control program associated with a subset associated with gear shifting, regardless of the subset selected by the pre-selector 4; and the fourth control program can relate to activating a second control program associated with the subset associated with gear shifting, regardless of the subset selected by the pre-selector 4.

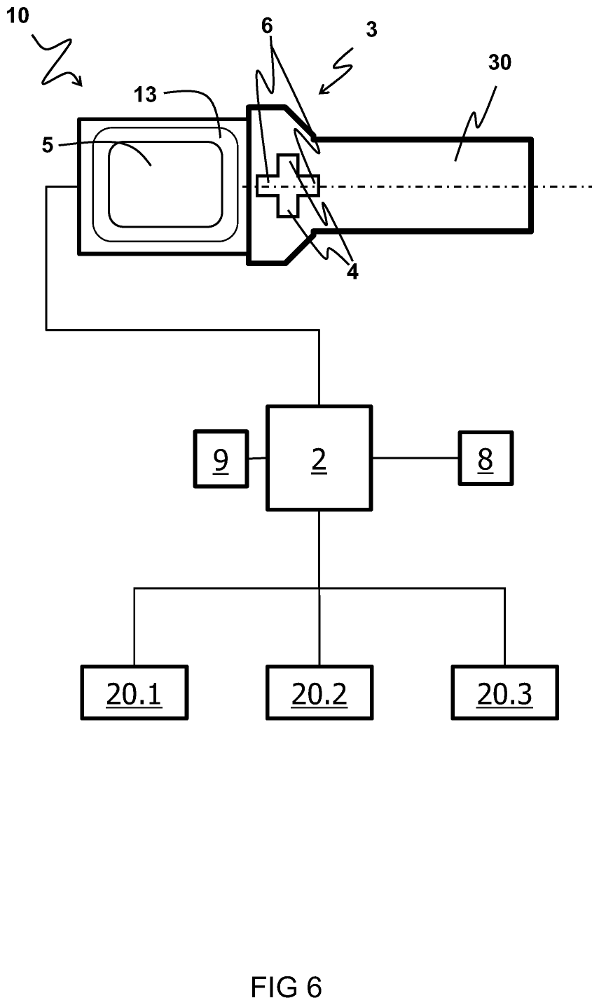

In the example of FIG. 6, the pre-selector 4 and the activator 6 are integrated into a single interface device, here a button. The single interface device includes multiple switches. A first switches senses depressing of a top end of the button, and acts as a first push-button 4A of the pre-selector 4 to navigate through the preconfigured subsets, in this case upwardly to pre-select a next subset. A second switch senses depressing of a lower end of the button, and acts as a second push-button 4B of the pre-selector 4 to navigate through the preconfigured subsets, in this case downwardly to pre-select a next subset. A third switch senses depressing of a top end of the button, and acts as a first push-button 6A of the activator 6 for activating the first control program. A fourth switch senses depressing of a lower end of the button, and acts as a second push-button 6B of the activator 6 for activating the fourth control program.

In view of each of the example above, it applies that a single switch can be configured to activate multiple different control programs. For instance, briefly operating an activator (e.g. shorter than a threshold time) can activate a first control program, while longer operating the activator (e.g. longer than the threshold time) can activate a second control program. Alternatively, or additionally, singly operating the activator (single-click) can activate a first control program, while doubly operating the activator (double-click) can activate a second control program. Alternatively, or additionally, lightly operating the activator (e.g. depressing a button lightly) can activate a first control program, while firmly operating the activator (e.g. depressing a button more firm, or deeper) can activate a second control program. Similarly, for instance, briefly operating the pre-selector (e.g. shorter than a threshold time) can preselect the next higher subset of control programs, while longer operating the pre-selector (e.g. longer than the threshold time) can preselect the next lower subset. Alternatively, or additionally, singly operating the pre-selector (single-click) can preselect the next higher subset, while doubly operating the selector (double-click) can preselect the next lower subset. Alternatively, or additionally, lightly operating the pre-selector (e.g. depressing a button lightly) can preselect the next lower subset, while firmly operating the pre-selector (e.g. depressing a button more firm, or deeper) can preselect the next higher subset.

In view of each of the examples above, it may apply that a particular subset is defined as default subset of control programs. The control module may be configured such that after a user has preselected a subset of control programs, the control module automatically reverts to the default subset of control programs. For instance, after the control module detects activation of a control program according to the user preselected subset, the control program may automatically revert to the default subset. Alternatively, after lapse of a predetermined amount of time, such as 1 second, or 2 seconds, after the user has pre-selected a subset the control program may automatically revert to the default subset. As an example, the default subset of control programs may relate to gear shifting. Hence, with the default subset selected, the activator can activate control programs relating to gear shifting. The user may e.g. preselect a subset of control programs related to lighting control. After the user has activated a lighting control program, e.g. switched lights on or off, or after lapse of the predetermined amount of time, the control module reverts to the default subset. Hence, the user need not preselect the subset of control programs related to gear shifting for activating a gear shifting control program, since the control module automatically reverts to this subset in this example. Return to the default subset can e.g. be indicated by the feedback device 5. In this example the feedback device 5 includes a display, such as an LCD or LED display. The display 5 can display various icons to the user indicative of a state of the bicycle, such as the available (subsets of) control programs, the currently pre-selected subset and the activation state of the current control program. The display may also display to the user a state of the bicycle associated with electric propulsion means of the bicycle, such as current state of charge of a battery and a power output by an electric motor of the bicycle. A solar panel 13 is provided, here at a perimeter of the display 5. The solar panel 13 may for example power the display 5. The solar panel may 13 additionally, or alternatively, power other electrical components, such as the processing unit 2. The feedback device 5, here the display, is integrated with the handlebar of the bicycle. The bicycle handlebar may for example be provided with an opening in which the feedback device 5 is accommodated. It will be appreciated that the display of the example of FIG. 6 can also be used as feedback device in the examples of FIGS. 1-5. It will be appreciated that the lights as described in view of the examples of FIGS. 1-5 can also be used as feedback device in the example of FIG. 6. The control module 10 can be configured such that the default subset can be chosen, e.g. preprogramed, by a user, e.g. using a control app on a mobile device which can be in communication with the control module 10.

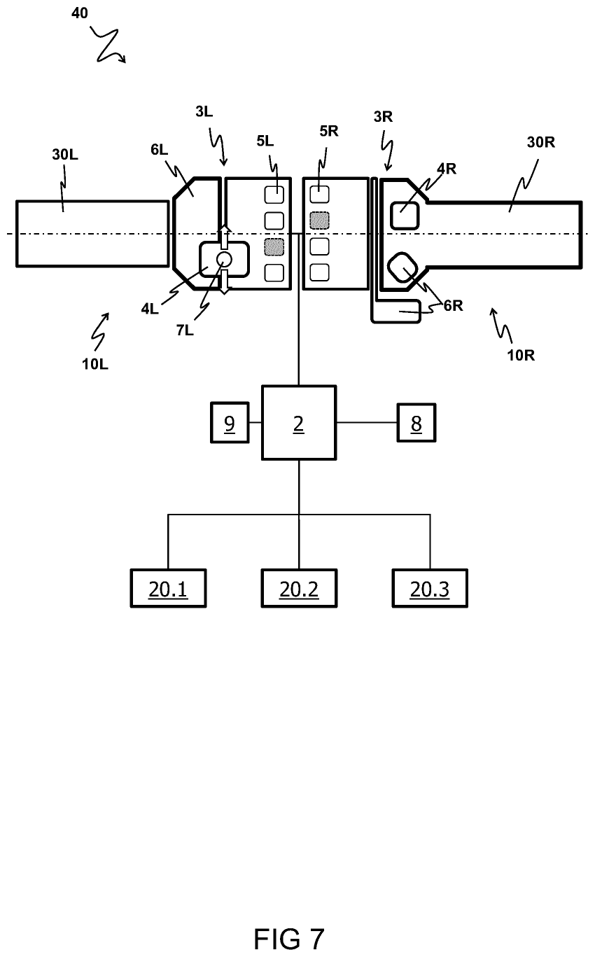

FIG. 7 shows a schematic example of a control system 40, comprising two control modules 10L, 10R, in this case the exemplary control modules as shown in FIGS. 1 and 2, but any of the other example of FIGS. 3-6 can be chosen. A left hand control module 10L corresponds to the control module of FIG. 1, the sensing arrangement 3L of which is arranged at a left grip portion 30L of a bicycle handlebar to be monomanually operated by a user's left hand. A right hand control module 10R corresponds to the control module 10 of FIG. 2, the sensing arrangement 3R of which is arranged at a right grip portion 30R of a bicycle handlebar to be monomanually operated by a user's right hand. The left and right sensing arrangements 3L and 3R, include respectively a left and right pre-selector 4L and 4R, as well as a left and right activator 6L and 6R. The left hand 10L and right hand 10R control modules may for instance be, substantially, equal but mirrored. In this example, the control system 40 shares a common processing unit 2 and memory 9, but it will be appreciated that each control module may have its own processing unit and memory.

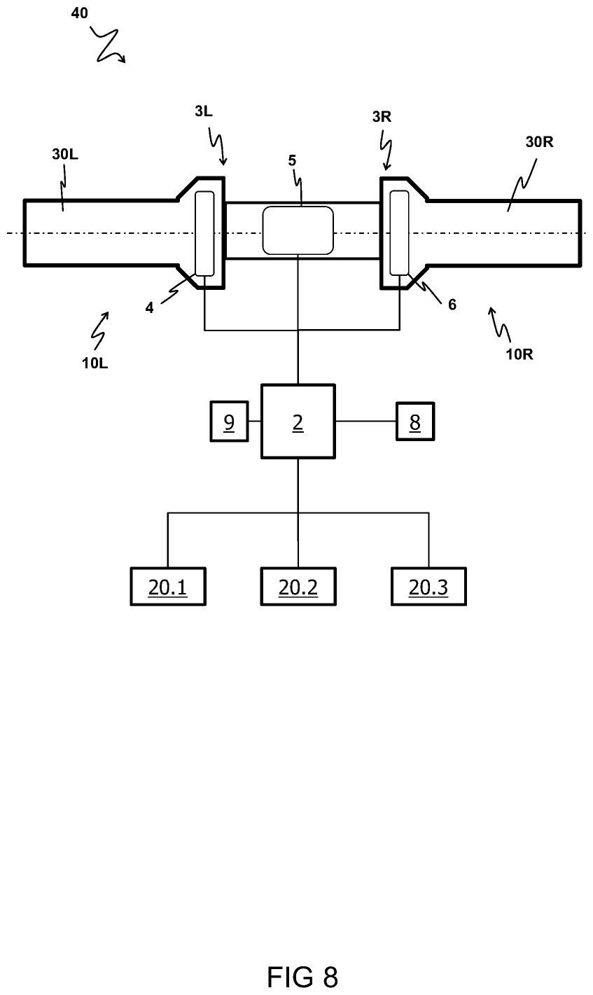

FIG. 8 shows a schematic example of a control system 40, comprising two control modules 10L, 10R. In this example, a left hand control module 10L has sensing arrangement 3L. In this example, the sensing arrangement 3L is arranged at a left grip portion 30L of a bicycle handlebar to be operated by a user's left hand. In this example, a right hand control module 10R has sensing arrangement 3R. In this example, the sensing arrangement 3R is arranged at a right grip portion 30R of the bicycle handlebar to be operated by a user's right hand. Here, the left sensing arrangements 3L includes a pre-selector 4. Here, the right sensing arrangement 3R includes an activator 6. It will be appreciated that this is generally applicable. In this particular example, the pre-selector 4 comprises a touch pad configured to detect swipe motions of e.g. a user's thumb. Swiping upwards can e.g. select the next higher subset of control programs. Swiping downwards can e.g. select the next lower subset of control programs. In this example, the activator 6 comprises a touch pad configured to detect swipe motions of e.g. a user's thumb. Swiping upwards can e.g. activate a first control program. Swiping downwards can e.g. activate a second control program. Here, the control system includes a display at the handlebar, for instance at or near a center of the handlebar, showing indications of the selected subset and/or activated control programs. It will be appreciated, however, that the touch pads can also be used in combination with other feedback devices as described in view of the other Figures. It is also possible that the touch pads are embodied as touch screens, hence having the functionality of both sensing arrangement and feedback device. In this example, the control system 40 shares a common processing unit 2 and memory 9, but it will be appreciated that each control module may have its own processing unit and memory.

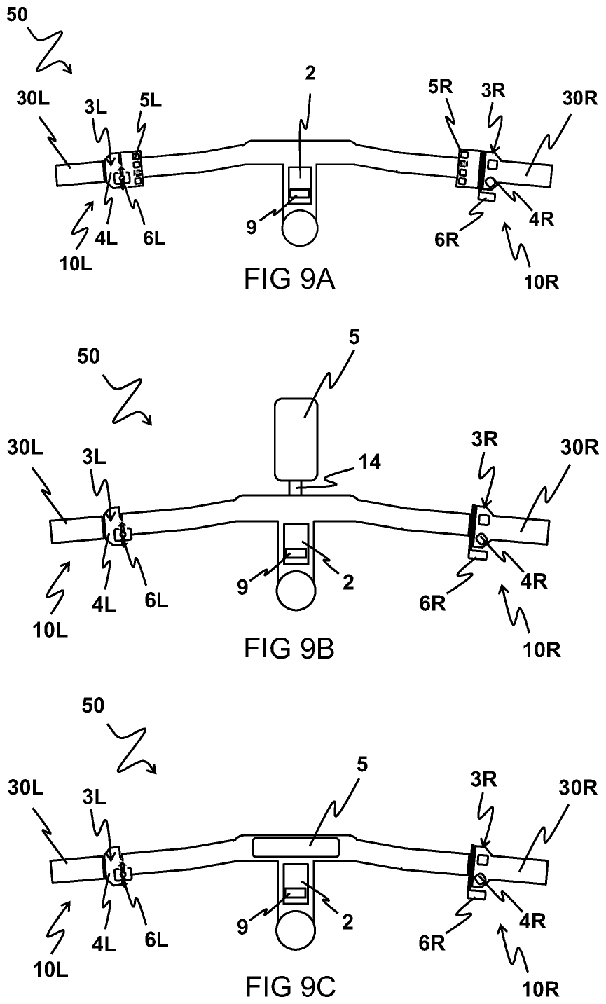

FIGS. 9A, 9B and 9C show a handlebar 50 for a bicycle, particular a flat-bar handlebar, for a mountain bike or city bicycle, including a left hand control module 10L and a right hand control module 10R, e.g. as described in view of FIG. 7. It will be appreciated that the control modules can also be used for drop-bar handlebars, e.g. for road-racing bikes. In particular for drop-bar handlebars, but also for flat-bar handlebars, the activator and/or the pre-selector 4 may be integrated with a brake lever of the bicycle. A processing unit 2 and associated memory 9, which is in these examples shared by the two control modules 10L, 10R, is in this example mounted to a stem portion of the handlebar 50. Each control module 10L 10R may alternatively include a respective processing unit and memory. In a particular example, the left pre-selector 4L may preselect a subset of auxiliary propulsion power control programs for controlling a power output of an electric motor, and the right pre-selector 4L may preselect a subset of automatic gearshift control programs for shifting gears. A power output of the electric motor may for example be increased and decreased by activating a power increase or decrease control program with the left activator 6L, and the transmission may be upshifted and down shifted to respectively a higher and lower gear by activating an upshift or downshift control program with the right activator 6R.

FIG. 9A shows an example where each control module 10L, 10R has a respective feedback device 5L, 5R, in this example each including four, e.g. LED, lights. FIGS. 9B and 9C show examples where the control modules 10L, 10R share a common feedback device 5. Each control module 10L 10R may be wirelessly or wiredly connected to the feedback device 5. In FIGS. 9B and 9C, the feedback device includes a display which is formed by a bicycle computer. In FIG. 9B, the bicycle computer is detachably mounted to the handlebar via a mount 14. It will be appreciated that the bicycle computer may be bicycle-specific, or that it may be a universal bicycle-independent bicycle computer arranged to be used for various bicycles and/or other vehicles. The bicycle computer may for example be a smartphone or tablet. The processing unit 2 and the feedback device 5 may be separate from the bicycle computer, or may alternatively, or additionally, be part of the bicycle computer. It may be preferred to separate the bicycle computer from the processing unit 2 and memory 9, as it allows functioning of the bicycle without the need for a separate bicycle computer. In the example of FIG. 9B, a separate processing unit 2 and memory 9 are provided, here integrated in a stem portion of the handlebar. In FIG. 9C, the display is integrated with the handlebar. This provides a particular compact setup. The display may for example be accommodated in an opening of the handlebar. The display is here non-detachable from the handlebar, but it will be appreciated that a detachable connection can also be provided.

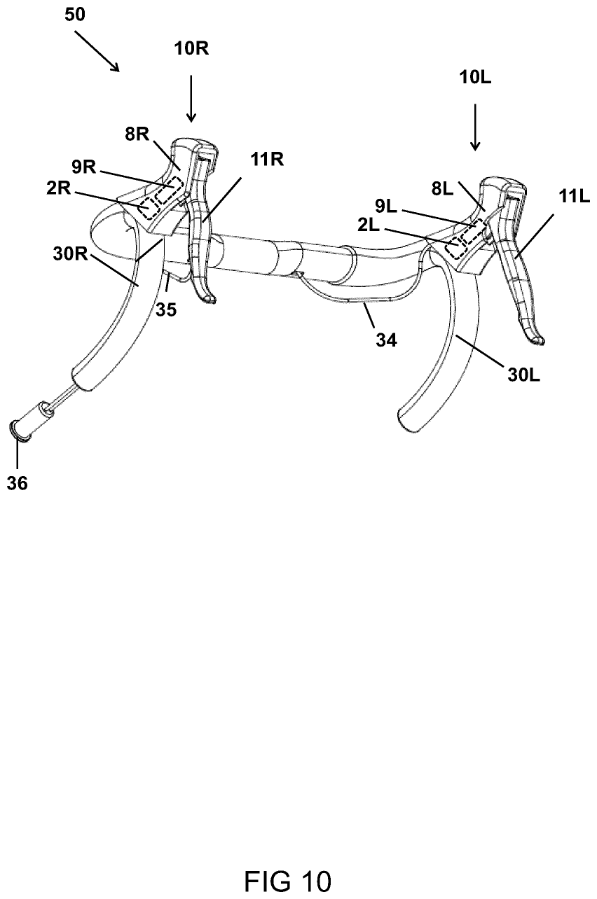

FIG. 10 shows an example where the control modules 10L and 10R are integrated with a respective left and right brake lever 11L, 11R of a bicycle. The example of FIG. 10 shows a drop-bar handlebar 50, but it will be appreciated that the same could apply to flat-bar handle bars 50. The control modules 10L, 10R each comprise a support body 8L, 8R, which is mounted to the handlebar 50, at a respective left and right grip portion 30L, 30R. The control modules 10L 10R, here, each comprise a respective processing unit 2L, 2R with associated memory 9L, 9R. The processing units 2L, 2R and associated memories 9L, 9R are is in this example accommodated by a housing of the support bodies 8L, 8R. The processing units 2L,2R and associated memories 9L,9R may also be accommodated by the respective levers 11L,11R. Hence, the control modules 10L and 10R can be manufactured to be “plug and play”, as the processing can take place locally within the modules 10L 10R. This facilitates assembly of a bicycle.

Each control module 10L, 10R may comprise a transmitter 36 for transmitting an electronic signal, e.g. an electronic shift signal, to various sensors and actuators of the bicycle. Here, each processing unit 2L,2R is connected a shared wireless transmitter 36 by means of a respective wire 34, 35. Here, the wires 34, 35 at least partly run through a cavity of the handlebar 50. The transmitter 36 is arranged to transmit a wireless signal, e.g. to an actuator. The transmitter 36 is for example arranged to transmit a wireless signal to a shift actuator of a transmission system to activate a transmission ratio shift. While the wireless transmitter 36 is described in view of this example, it will be appreciated that any other example described herein may also include a wireless transmitter 36.

The lever 11L, 11R is movable in a brake direction to activate a brake action, and in an actuation direction, different from the brake direction, to preselect, activate and/or deactivate any control program(s) stored in memory. It will be appreciated that in addition to the levers 11L, 11R, the control modules may include additional levers, e.g. adjacent levers 11L, 11R, for pre-selecting subsets and/or activating control programs.

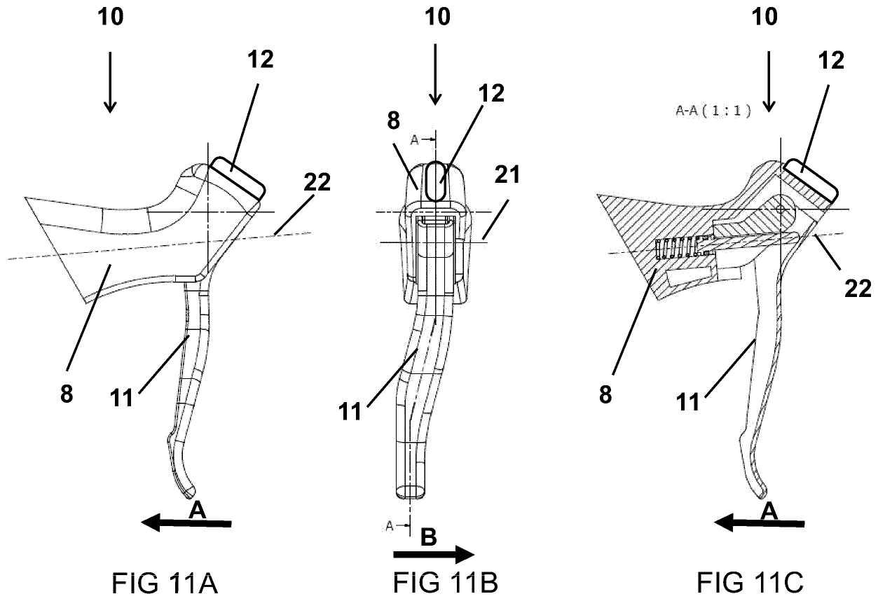

FIGS. 11A-11C show an example of an integrated control module 10, wherein the brake direction is indicated by arrow A and the actuation direction by arrow B. In the brake direction, the lever is pivotable relative to the support body 8 about a first pivot axis 21. In the actuation direction, the lever is pivotable relative to the support body 8 about a second pivot axis 22. In this example, the first pivot axis 21 and the second pivot axis 22 are perpendicular to each other. It may be desired to separate the brake direction from the actuation direction for safety reasons, to allow a user to brake at all times, regardless of a state of control device. It will be appreciated that the brake position may regarded as an additional actuation position, in which the brake action may be executed by a control program stored in the memory. The memory may accordingly include a subset of brake control programs for controlling a brake actuator of the bicycle, wherein, e.g., a brake control program is selectively actuatable by moving the lever in the brake direction to the brake position. Alternatively, the brake action may not be executable by a control program stored in the memory, but may instead be executed by other means, e.g. hydraulically or mechanically via a brake cable.

In a particular example, the lever 11 is associated with the activator 6, and can accordingly be used for activating a control program from a pre-selected subset of control programs. A separate actuation organ 12, here a push button, may be associated with the pre-selector 4, for pre-selecting of a desired subset of control program. Alternatively, the lever 11 may be associated with the pre-selector and the activator with other means, e.g. the push button 12.

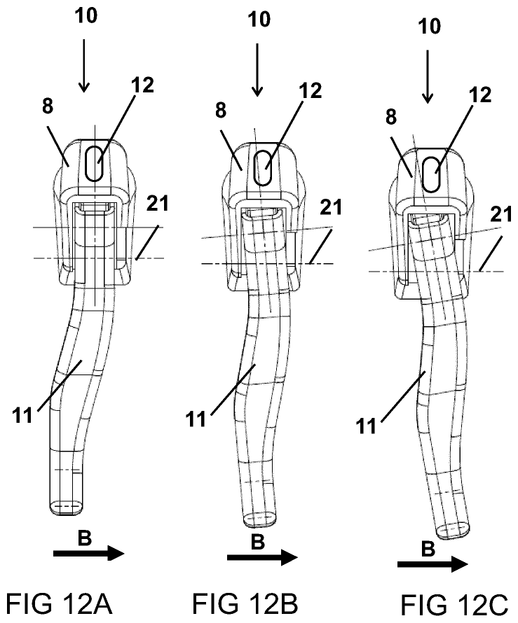

FIGS. 12A-12C show a frontal view of an integrated control module 10, in three respective positions. In FIG. 12A, the lever 11 is in a neutral position, relative to the support body 8. In this case, for a drop-bar handlebar the neutral position corresponds to lever 11 pointing downward in use. In case of a flat-bar handlebar, the neutral position may correspond to lever 11 pointing horizontally in use, substantially parallel to the handlebar. FIG. 12B shows the lever 11 being in a first actuation position. The first actuation position here corresponds to a first actuation state of the activator. For example, in the first actuation position, the lever 11 may actuate the sensing arrangement corresponding to a first actuation state of the activator. FIG. 12C shows the lever 11 being in a second actuation position. The second actuation position here corresponds to a second actuation state of the activator. For example, in the second actuation position, the lever 11 may actuate the sensing arrangement corresponding to a second actuation state of the activator. It will be appreciated that further actuation positions may be provided, e.g. beyond the second actuation position, corresponding to further actuation states of the activator. Bringing the lever 11 to the first actuation position may e.g. cause selection of a first control program, and bringing the lever 11 to the second actuation position may e.g. cause selection of a second control program.

The first and second actuation positions are reachable, by moving the lever 11 in the second direction B. In particular, the first actuation position is reachable, by moving the lever 11 by a first amount, and the second actuation position is reachable by moving the lever 11 by a second amount. Here the first amount and the second amount are defined from the neutral position. The first amount and the second amount are different. The second amount is in particular larger than the first amount. The lever 11 can thus be moved from its neutral position to the second actuation position, via the first actuation position. Similarly, when returning the lever 11 from the second actuation position to its neutral position, e.g. using a return spring, after release of the lever 11, the lever 11 moves through the first actuation position. In this example, the second actuation position is positioned beyond the first actuation position when seen from the neutral position. It will be appreciated that it is also possible that the second actuation position is positioned on the opposite side of the neutral position relative to the first actuation position, e.g. to the left of the neutral position in the example of FIGS. 12A-12C.

The respective actuation positions of the lever 11 in this example correspond to a predefined, e.g. indexed, pivot amplitude of the lever 11 in the second direction relative to the support body 8. The sensing arrangement may for example comprise an angular sensor for measuring a rotation magnitude of the lever 11 about the second pivot axis 22 relative to the support body 8. The different actuation positions of the lever 11 may be made noticeable for the cyclist for example by means of local resistance increases or decreases along the pivot path of the lever 11. This can be done with a biasing member.

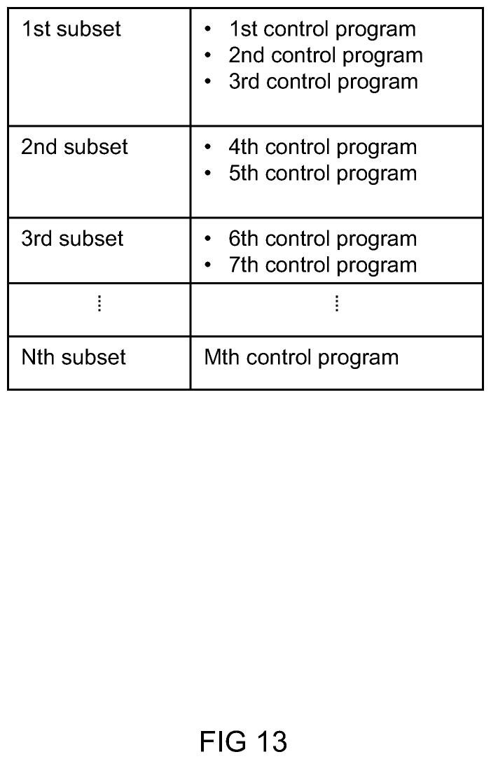

FIG. 13 shows a schematic example of N pre-selectable subsets of different control programs stored by the memory 9, and the associated control programs of each subset. Each subset is pre-selectable using a pre-selector. From a pre-selected subset, any control program is selectively activatable using an activator. Here, a total of M control programs are stored in memory. It will be appreciated that some control programs may be part of multiple subsets.

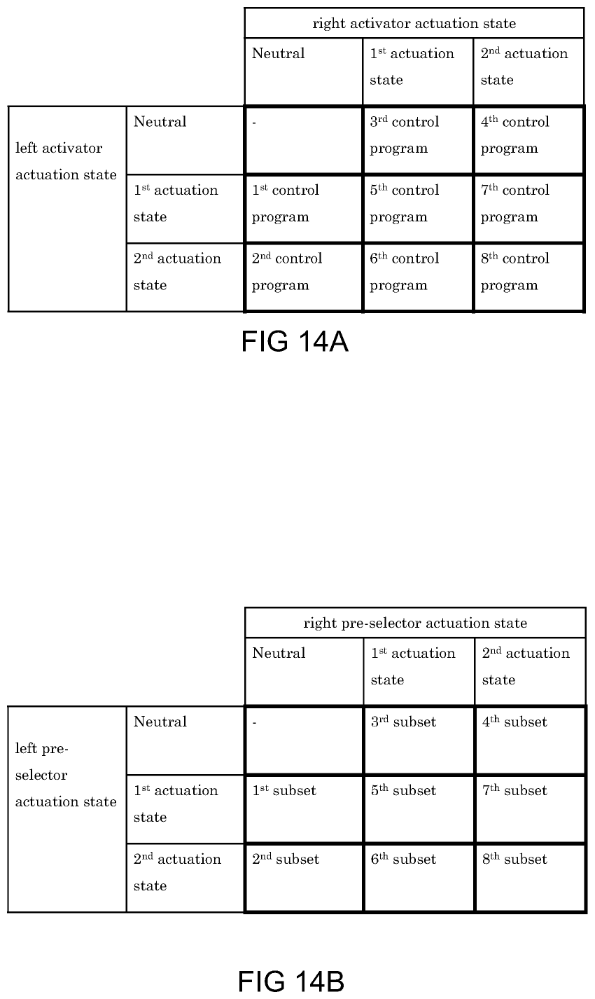

FIG. 14A shows a schematic example of a pre-selectable subset of different control programs stored by the memory 9, which subset here includes eight control programs. Each control program is selectively activatable using the left activator 6L and the right activator 6R, of the left 10L and right 10R control modules respectively. The subset of control programs may be preselected with the left pre-selector 4L or with the right pre-selector 4R, or both the left preselector 4L and the right preselector 4R. The left activator 6L and the right activator 6R may for example be respectively associated with the left and right levers 11L, 11R, e.g. as shown in FIG. 9, and the pre-selector may be associated with one or more dedicated actuation organs, such as button 12.

Once pre-selected, any one of the control programs of the subset is activatable using the left activator 6L and/or the right activator 6R. In this example, each activator has two actuation states, which are reachable from a neutral. It will be appreciated that in other examples, the activator 6L, 6R may include only one actuation state, or more than two actuation states. Here, the subset of control programs includes eight different control programs, which are selectively activatable using the left and right activators 6L, 6R. Here, a first control program is activated if the left activator 6L is in the first actuation state while the right activator 6R is in neutral. A second control program is activated if the left activator 6L is in the second actuation state while the right activator 6R is in neutral. Similarly, a third and fourth control program are activated if the left activator 6L is in neutral, while the right activator 6R is, respectively, in the first actuation state and the second actuation state. A fifth and sixth control program is activated if the right activator 6R is in the first actuation state, while the left activator 6L is, respectively, in the first actuation state and the second actuation state. A seventh and eight control program is activated if the right activator 6R is in the second actuation state, while the left activator 6L is, respectively, in the first actuation state and the second actuation state. No control program may be activated when both left and right activators 6L, 6R are in neutral, however it is envisioned that a ninth control program may be activated when the left and right activators 6L, 6R are in neutral.

It will be appreciated that e.g. time-dependent actuation and repetitive actuation of the activators 6L, 6R could enable additional functionality. It will also be appreciated that this presented schematic can be extended or reduced. The control programs may for example be used for various operations including transmission upshift, transmission downshift, transmission double upshift, transmission double downshift, increasing electric motor output, decreasing electric motor output, increasing suspension stiffness, decreasing suspension stiffness, increasing seat post length, decreasing seat post length, switch on lights, switch off lights, taking a photograph, etc.

In an alternative example, the levers 11L, 11R are used for pre-selecting subset of control programs, instead of for activating control programs from a pre-selected subset. FIG. 14B shows an exemplary schematic of eight pre-selectable subsets of control programs, that are pre-selectable using combinations of the left and right pre-selector. In this example, each pre-selector has two actuation states. A control program may be activated from a pre-selected subset by other means, e.g. by additional buttons. In another example, actuating of the left lever 11L can function as pre-selector 4L for preselecting the subset of control programs, and actuating of the right lever 11R can function as activator 6R for activating any one of the control programs of the subset. The actuating of the pre-selector 4L to the first actuation state can e.g. select a first subset of control programs and actuating the pre-selector 4L to the second actuation state can e.g. select a second subset of control programs. Alternatively, actuating the pre-selector to a first (optionally single) actuation state can switch to a next subset of a list of subsets, e.g. cyclically moving through the list of subsets. Actuating the pre-selector to the first actuation state can switch to a next higher subset of a list of subsets, while actuating the pre-selector to the second actuation state can switch to a next lower subset of a list of subsets, or vice versa.

Similarly, actuating of the right lever 11R can function as pre-selector 4R for preselecting the subset of control programs, and actuating of the left lever 11L can function as activator 6L for activating any one of the control programs of the subset.

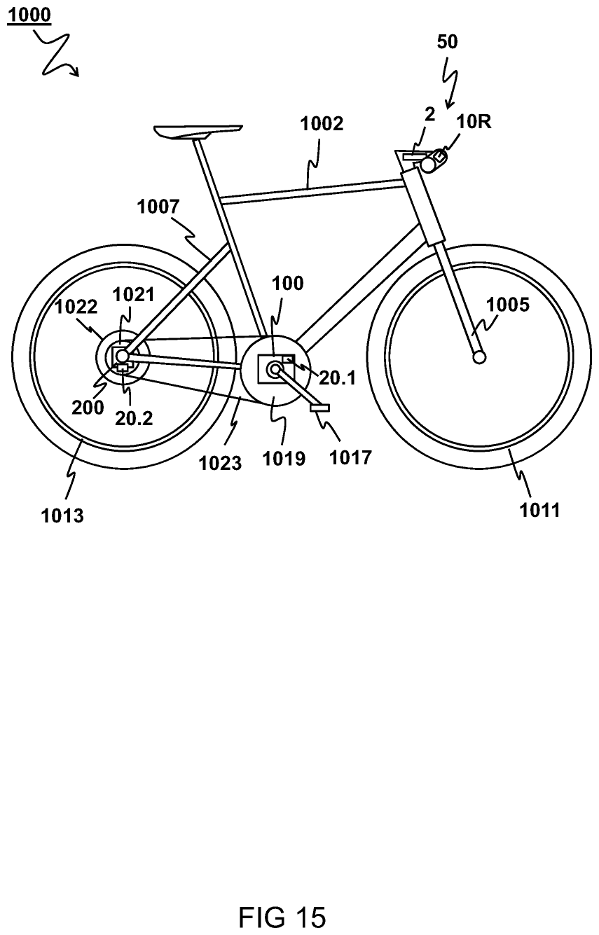

FIG. 15 shows a bicycle 1000. The bicycle 1000 comprises a frame 1002 with a front fork 1005 and a rear fork 1007, as well as a front wheel and a rear wheel 1011, 1013 located in the front and rear fork respectively. The bicycle 1000 further comprises a crank 1017, and a front chain wheel 1019. The bicycle 1000 also comprises a rear sprocket 1021 and a rear wheel hub 1022 of the rear wheel 1013, wherein a chain or belt 1023 threads over the front chain wheel 1019 and rear sprocket 1021. In this example, the bicycle 1000 comprises a first transmission 100, which is interconnected between the crank 1017 and front chain wheel 1019, and a second transmission 200 which is interconnected between the rear sprocket 1021 and the rear wheel hub 1022. The first transmission 100 is operable according to multiple transmission ratios and includes a first gearshift actuator 20.1 for actuating a gear shift with the first transmission 100. The second transmission 200 is also operable according to multiple transmission ratios and includes a second gearshift actuator 20.2 for actuating a gear shift with the second transmission 200.

The bicycle in this example includes a flat-bar handlebar 50, for example as shown in FIG. 9A or 9B, having a right hand control module 10R as described herein. It will be appreciated that alternatively, or additionally, the bicycle can include a left hand control module 10L.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

For the purpose of clarity and a concise description features are described herein as part of the same or separate embodiments, however, it will be appreciated that the scope of the invention may include embodiments having combinations of all or some of the features described.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A control module for controlling a plurality of bicycle actuators on a bicycle, comprising a memory storing a set of a plurality of control programs for controlling the plurality of bicycle actuators, and a sensing arrangement configured for detecting a user-actuation thereof, wherein the control module is so arranged that each of the plurality of control programs is selectively activatable and/or deactivatable on a user-actuation of the sensing arrangement.

2. The control module of claim 1, wherein the set of the plurality of control programs comprises a first subset of control programs and a second subset of control programs, and wherein the control module is so arranged that any one of said first subset and second subset is pre-selectable from the plurality of control programs with a pre-selector of the sensing arrangement, and that any one control program of the pre-selected first or second subset of control programs is activatable and/or deactivatable with an activator of the sensing arrangement.

3. The control module of claim 2, wherein each subset of control programs includes at most two control programs, such as at most one control program.

4. The control module of claim 2, wherein the pre-selector is configured for switching between at most two actuation states, and/or wherein the activator is configured for switching between at most two actuation states.

5. (canceled)

6. The control module of claim 2, wherein the pre-selector and the activator are integrated.

7. The control module of claim 2, comprising a confirmator for confirming a pre-selection of a subset of control programs.

8. The control module of claim 7, wherein the pre-selector and the confirmator are integrated.

9. The control module of claim 1, comprising one or more sensors for sensing a state of the bicycle, its user, and/or its environment, wherein a subset of control programs is automatically pre-selected based on the sensed state.

10. The control module of claim 1, comprising a default subset of control programs, wherein the control module is so configured that the default subset of control programs is automatically pre-selected upon detection of a predefined time period of inactivity of the sensing arrangement and/or upon detection of an activation of a control program.

11. (canceled)

12. The control module of claim 1, wherein the sensing arrangement is configured to be monomanually actuatable by a single hand of a user while bicycling.

13.-17. (canceled)

18. The control module of claim 1, comprising a feedback device configured for providing feedback to a user of a currently pre-selected subset of control programs, and/or an activation state of said currently pre-selected subset of control programs, wherein the feedback is one or more of visual feedback, haptic feedback, and audio feedback.

19. (canceled)

20. (canceled)

21. The control module of claim 1, the bicycle comprising an electric propulsion motor for propelling the bicycle, wherein the control module comprises a subset of power control programs for controlling an output power of the electric propulsion motor, wherein said subset includes a power-up control program for increasing a power output of the electric propulsion motor and a power-down control program for decreasing the power output of the electric propulsion motor.

22. (canceled)

23. (canceled)

24. (canceled)

25. The control module of claim 1, comprising one or more of a subset of brake control programs, a subset of gearshift control programs, a subset of lighting control programs, a subset of seat post adjustment control programs, a subset of suspension adjustment control programs, a subset of auxiliary propulsion power control programs, a subset of horn control programs, a subset of turn indicator control programs, and a subset of regenerative braking control programs.

26. The control module of claim 1, wherein the bicycle comprises a transmission having one or more gear selection actuators for selecting any one of a plurality of gears of the transmission, and the control module comprises one or more of:
a subset of automatic gear selection control programs, said subset including an automatic gear selection control program configured for automatically selecting a gear of the transmission based on a measured state of the bicycle, particularly while not allowing a user-requested gear selection;
a subset of semi-automatic gear selection control programs, said subset including a semi-automatic gear selection control program configured for automatically selecting a gear of the transmission based on a measured state of the bicycle, while also allowing a user-requested gear selection; and
a subset of manual gear selection control programs, said subset including a manual gear selection control program configured for selecting a gear of a transmission.

27. (canceled)

28. (canceled)

29. The control module of claim 1, wherein the bicycle comprises a transmission and a gearshift actuator for shifting gears of the transmission, and wherein the control module comprises an upshift control program for, with the gearshift actuator, upshifting to a higher gear and/or a downshift control program for, with the gearshift actuator, downshifting to a lower gear.

30. The control module of claim 1, the bicycle comprises a transmission having a first gearshift actuator and a second gearshift actuator for shifting gears of the transmission, and wherein the control module comprises a first subset of control programs for controlling only the first gear shift actuator and a second subset of control programs for controlling only the second gear shift actuator.

31. The control module of claim 30, wherein the first subset includes a first upshift control program and first downshift control program for controlling the first gearshift actuator to respectively upshift and downshift, and the second subset includes a second upshift control program and a second downshift control program for controlling the second gearshift actuator to respectively upshift and downshift the transmission.

32. (canceled)

33. The control module of claim 1, wherein the control module is configured to detect an actuation time duration of the sensing arrangement, and activate a control program in dependence of a detected actuation time duration.

34. The control module of claim 1, wherein the control module is configured to detect an intermediate time period between consecutive actuations, and activate a control program in dependence of a detected intermediate time period.

35. A control system for controlling a plurality of bicycle actuators of a bicycle comprising:
a memory storing a set of a plurality of control programs for controlling the plurality of bicycle actuators;
a first control module having a left sensing arrangement configured to be monomanually actuatable by a left hand of a user while bicycling; and
a second control module having a right sensing arrangement configured to be monomanually actuatable by a right hand of a user while bicycling;
wherein the control system is so arranged that each of the plurality of control programs is selectively activatable and/or deactivatable on a user-actuation of sensing arrangements.

36. The control system of claim 35, wherein the set of the plurality of control programs comprises a first subset of control programs and a second subset of control programs, and wherein the control system is so arranged that any one of said first subset and second subset is pre-selectable from the plurality of control programs with a pre-selector of the sensing arrangements, and that any one control program of the pre-selected first or second subset of control programs is activatable and/or deactivatable with an activator of the sensing arrangements.

37. The control system of claim 36, wherein the first control module includes the pre-selector and the second control module includes the activator, or wherein the second control module includes the pre-selector and the first control module includes the activator.

38. A control system for controlling a plurality of bicycle actuators of a bicycle comprising a first control module comprising the control module of claim 1, the sensing arrangement of which being configured to be monomanually actuatable by a left hand of a user while bicycling; and a second control module of claim 1, the sensing arrangement of which being configured to be monomanually actuatable by a right hand of a user while bicycling.

39. (canceled)

40. The control system of claim 35, wherein the first and second control modules are the same or mirrored with respect to each other.

41. The control system of claim 35, wherein the first control module and the second control module are configured to conjunctively pre-select one or more subsets of control programs, and/or activate one or more control programs from a preselected subset.

42.-50. (canceled)
